(19) United States
(12) Patent Application Publication
(10) Pub. No.: US 2026/0101263 A1
(43) Pub. Date: Apr. 9, 2026

(54) APPARATUS AND METHODS FOR PROVIDING STABLE WIRELESS COMMUNICATION

(71) Applicant: Ghost Kits Inc., Wilmington, DE (US)

(72) Inventors: Casper Miko-Camilla HANNEY, Los Angeles, CA (US); Cyrus Wesley KEENAN-EASON, Madison, WI (US); Christopher Lee HANNEY, Broomall, PA (US)

(73) Assignee: Ghost Kits Inc., Wilmington, DE (US)

(21) Appl. No.: 19/351,140

(22) Filed: Oct. 6, 2025

Related U.S. Application Data
(60) Provisional application No. 63/703,950, filed on Oct. 5, 2024.

(51) Int. Cl. H04W 40/12; H04W 48/16; H04W 84/04

(52) U.S. Cl. CPC H04W 40/12; H04W 48/16; H04W 84/042

(57) ABSTRACT

Provided are methods and apparatus that provide stable internet access to secondary devices during large data uploads via local area network and radio access technology by actively monitoring available inter-frequency and inter-public land mobile network serving cells and automatically transitioning the active connection between serving cells based on network quality information, without disrupting the active user connection by utilizing an intermediary server to route and process the network traffic in a secure manner.

### CROSS-REFERENCE TO RELATED APPLICATION

The present non-provisional patent application claims priority to and the benefits of U.S. Provisional Patent Application No. 63/703,950 filed on Oct. 5, 2024, the disclosure of which is hereby incorporated herein in its entirety for all purposes by specific reference thereto.

### FIELD OF DISCLOSURE

This disclosure relates generally to the technical fields of electronics, computer-readable media, computer engineering, and more specifically, but not exclusively, to apparatus and methods for providing stable wireless communication.

### BACKGROUND

Radio communication networks are used with increasing frequency for telecommunications and include technologies like Global System for Communication (GSM), Universal Mobile Telecommunications System (UMTS), Long Term Evolution (LTE), and most recently with the introduction of New Radio (NR) or 5G access technology. NR 5G technology introduced faster speeds and lower latency, expanding network access to even more devices.

As radio communication technology advances, an increasing number of consumer devices support wireless communications via local area networking (WLAN). This includes consumer and cinema-grade mirrorless cameras and related accessories. This poses an increasing need for stable wireless connections in a number of locations and situations, with an emphasis on network speed and stability as large data uploads suffer from unstable network conditions.

There is presently market demand for advanced computer-implemented tools configured to address these issues in a manner that at least significantly mitigates detrimental effects of current technologies. Accordingly, there are previously unaddressed and long-felt industry needs for methods and apparatus that improve upon conventional methods and conventional apparatus.

### SUMMARY

As is described in greater detail herein, the instant disclosure describes apparatus and methods that provide stable wireless communication. In examples, the provided methods and apparatus can provide stable wireless communication for large file uploads during inter-public land mobile network (PLMN) discoveries and transitions.

As described in greater detail herein, the instant disclosure describes various apparatus and methods for generating at least a portion of a machine configured to provide a stable Internet connection. In examples, the machine can include at least a portion of an electronic digital information management system configured as a set of computer-executable instructions (e.g. software instructions), where the computer-executable instructions can be stored on a suitable non-transitory computer-readable data storage element, a suitable non-transitory computer-readable medium, or both. The provided systems and methods address the previously unaddressed and long-felt industry needs for methods and apparatus that improve upon the conventional methods and the conventional apparatus.

In an example, provided is a computer-implemented method for automatically providing a stable Internet connection. The method can be performed by a computing device (e.g. user equipment (UE)) including at least one processor. In examples, the method can include: (i) performing inter-frequency and inter-public land mobile network (PLMN) cell discovery to establish a current active connection between the UE and a PLMN; (ii) generating information describing candidate alternative connections from cell frequency and quality metrics identified during the PLMN cell discovery, where: (a) current active connection metrics and past connection quality metrics are used to generate the information describing the candidate alternative connections; and (b) the information describing the candidate alternative connections comprises information describing a best available PLMN to which to connect; (iii) transitioning the active connection of the UE from the current active connection to an alternative connection described in the information describing the candidate alternative connections; and (iv) maintaining secondary connected device communications and upload processes uninterrupted between the UE and a secondary user device via local area network (LAN) during the transitioning of the active connection of the UE from the current active connection to the alternative connection.

In an example, the performing the PLMN cell discovery can further include: (i) receiving, from a serving cell, information including: (a) a list of frequencies, (b) a reference signal received quality (RSRQ), and (c) a PLMN identifier (ID); (ii) storing the received information in a UE memory; (iii) preparing information describing a summary of the received information; and (iv) transmitting the summary of the received information to a remote server.

In an example, the computer-implemented method can further include generating information describing the current active connection by combining PLMN cell discovery information describing characteristics of the current active connection with information describing: (i) quality information of the current active connection over time; (ii) historical connection quality information of the discovered cells and geographically relevant cells, available to the UE via locally stored data and remotely archived data; (iii) historic bandwidth and data transfer rates; (iv) trending signal quality and strength; (v) speed of network transition; (vi) number of active cells; (vii) current quality information of discovered cells, made available via network discovery; (viii) preferring high-bandwidth radio access technologies; (ix) preferring low-traffic frequency bands; or (x) a combination thereof.

In an example, the maintaining the secondary connected device communications and upload processes uninterrupted between the UE and the secondary user device can further include preserving an active data connection of the secondary device by: (i) encapsulating data packets in the network traffic with additional data headers that direct network traffic to an intermediate server; and (ii) removing, at the intermediate server, the additional data headers to enable: (a) additional routing of the data packets; (b) re-ordering of the data packets when the data packets are received out-of-order; (c) consolidating different network source Internet Protocol (IP) addresses into one single outbound IP address; (d) repeating data transmission of dropped packets; or (e) a combination thereof.

In an example, provided is a method of operating user equipment to provide a stable Internet connection during active communications to secondary user devices via local area network (LAN), including: (i) performing inter-frequency and inter-public land mobile network cell discovery; (ii) generating optimization solutions for the active connection using the discovered cell frequency and quality metrics, where the current connection and past connection quality metrics are included in generating the optimization solutions; including determining the best available PLMN to support the active connection; (iii) transitioning the user equipment's active PLMN to an alternative selected from the inter-PLMN and inter-frequency cell discovery based on generated optimization solutions; and (iv) maintaining secondary connected device communications and upload processes uninterrupted during active PLMN transitions.

In an example, performing the network discovery can include: (i) receiving information including a list of frequencies, reference signal received quality (RSRQ), and PLMN identifies (IDs) from a serving cell; (ii) storing and summarizing the received information locally; and (iii) transmitting this summarization to a remote server for long-term storage.

In an example, discovery information can be combined with other available information to generate an optimization solution for the active connection, including, but not limited to; the current active connection's quality information, tracked over time; (i) historical quality information related to the discovered cells and geographically relevant cells, available to the user equipment via locally stored data and remotely archived data; including historic bandwidth and transfer rates, trending signal quality and strength, speed of network transition, number of active cells; (ii) the current quality information of the discovered cells, made available via network discovery; and (iii) general known optimization factors including preferring high-bandwidth radio access technologies; preferring low-traffic frequency bands.

In an example, the user equipment's active PLMN can be transitioned to an alternative while preserving the secondary device's active data connections, including: encapsulating network traffic with additional data headers, thereby directing network traffic to an intermediate server; where said intermediate server removes the added data headers, enabling additional routing and processing of the data packets including, but not limited to; re-ordering packets received out-of-order; consolidating different network source IP addresses into one single outbound address; repeating data transmission for dropped packets.

In examples, provided is a system configured to generate at least a portion of a machine configured to provide stable wireless communication. The system can include (i) an electronic processor configured to execute a set of computer-executable instructions, (ii) a user display device communicatively coupled to the electronic processor; and (iii) a memory communicatively coupled to the electronic processor and storing the set of computer-executable instructions. The set of computer-executable instructions can be configured to cause the electronic processor to perform at least a portion of a method described herein.

In an example, provided is a system configured to automatically provide stable wireless communication. The system can include (i) an electronic processor configured to execute a set of computer-executable instructions; (ii) a wireless cellular communications transceiver communicatively coupled to the electronic processor; (iii) a local area network (LAN) transceiver communicatively coupled to the electronic processor; and (iv) a memory communicatively coupled to the electronic processor and storing the set of computer-executable instructions. The set of computer-executable instructions can be configured to cause the electronic processor to: (i) perform inter-frequency and inter-public land mobile network cell discovery to establish a current active connection between User Equipment and a PLMN; (ii) generate information describing candidate alternative connections from cell frequency and quality metrics identified during the PLMN cell discovery, where: (a) current active connection metrics and past connection quality metrics are used to generate the information describing the candidate alternative connections; and (b) the information describing the candidate alternative connections comprises information describing a best available PLMN to which to connect; (iii) transition the active connection of the UE from the current active connection to an alternative connection described in the information describing the candidate alternative connections; and (iv) maintain secondary connected device communications and upload processes uninterrupted between the UE and a secondary user device via local area network during the transitioning of the active connection of the UE from the current active connection to the alternative connection.

In an example, the instructions configured to cause the electronic processor to perform the PLMN cell discovery can further include instructions configured to cause the electronic processor to: (i) receive, from a serving cell, information including: (a) a list of frequencies, (b) a reference signal received quality, and (c) a PLMN identifier (ID); (ii) store the received information in a UE memory; (iii) prepare information describing a summary of the received information; and (iv) transmit the summary of the received information to a remote server.

In an example, the memory further stores instructions configured to cause the electronic processor to generate information describing the current active connection by combining PLMN cell discovery information describing characteristics of the current active connection with information describing: (i) quality information of the current active connection over time; (ii) historical connection quality information of the discovered cells and geographically relevant cells, available to the UE via locally stored data and remotely archived data; (iii) historic bandwidth and data transfer rates; (iv) trending signal quality and strength; (v) speed of network transition; (vi) number of active cells; (vii) current quality information of discovered cells, made available via network discovery; (viii) preferring high-bandwidth radio access technologies; (ix) preferring low-traffic frequency bands; or (x) a combination thereof.

In an example, the instructions configured to cause the electronic processor to maintain the secondary connected device communications and upload processes uninterrupted between the UE and the secondary user device can further include instructions configured to cause the electronic processor to preserve an active data connection of the secondary device by: (i) encapsulating data packets in the network traffic with additional data headers that direct network traffic to an intermediate server; and (ii) removing, at the intermediate server, the additional data headers to enable: (a) additional routing of the data packets; (b) re-ordering of the data packets when the data packets are received out-of-order; (c) consolidating different network source Internet Protocol (IP) addresses into one single outbound IP address; (d) repeating data transmission of dropped packets; or (e) a combination thereof.

Embodiments of the disclosed systems and methods are directed to processes and techniques, including at least partially automated processes and at least partially automated techniques, to generate at least a portion of a machine configured to provide stable wireless communication. In some embodiments, the disclosed systems include computer architecture components that can provide interfaces, code snippets, data structures, and information relationships to enable generating at least a portion of a machine configured to provide stable wireless communication.

In an embodiment, the disclosure is directed to an apparatus configured to generate at least a portion of a machine configured to provide stable wireless communication.

In an example, provided is an apparatus capable of a method described hereby, including: (i) at least one non-transitory programmable electronic data processing machine having instructions embodied thereon; (ii) a means for processing incoming and outgoing wireless cellular data communications; and (iii) a means for providing a local area network to external secondary user devices, either wired or wireless, by which data communications can be exchanged.

The apparatus can include a non-transitory computer-readable medium storing a set of computer-executable instructions and an electronic processor or electronic co-processors. When executed by the electronic processor or electronic co-processors, the instructions can cause the electronic processor or electronic co-processors (or a device of which they are part) to perform a set of operations that implement at least a portion of a disclosed method.

In an embodiment, the disclosure is directed to a non-transitory computer-readable medium storing a set of computer-executable instructions, where the set of instructions can be executed by an electronic processor or co-processors to cause the processor or co-processors (or a device of which the processor or co-processors are a constituent part) to perform a set of operations that implement at least a portion of a disclosed method.

In an example, provided is a non-transitory computer-readable medium, including processor-executable instructions stored thereon configured to cause a processor to perform at least a portion of a method described herein.

In an example, provided is a non-transitory computer-readable medium, including processor-executable instructions stored thereon configured to cause a processor to perform at least a portion of a function described herein.

In an example, provided is a non-transitory computer-readable medium, including processor-executable instructions stored thereon configured to cause a processor to: (i) perform inter-frequency and inter-public land mobile network cell discovery to establish a current active connection between User Equipment and a PLMN; (ii) generate information describing candidate alternative connections from cell frequency and quality metrics identified during the PLMN cell discovery, where: (a) current active connection metrics and past connection quality metrics are used to generate the information describing the candidate alternative connections; and (b) the information describing the candidate alternative connections comprises information describing a best available PLMN to which to connect; (iii) transition the active connection of the UE from the current active connection to an alternative connection described in the information describing the candidate alternative connections; and (iv) maintain secondary connected device communications and upload processes uninterrupted between the UE and a secondary user device via local area network during the transitioning of the active connection of the UE from the current active connection to the alternative connection.

In an example, the processor-executable instructions stored thereon configured to cause the processor to perform the PLMN cell discovery can further include processor-executable instructions configured to cause the processor to: (i) receive, from a serving cell, information including: (a) a list of frequencies, (b) a reference signal received quality, and (c) a PLMN identifier (ID); (ii) store the received information in a UE memory; (iii) prepare information describing a summary of the received information; and (iv) transmit the summary of the received information to a remote server.

In an example, the non-transitory computer-readable medium can further include processor-executable instructions stored thereon configured to cause the processor to generate information describing the current active connection by combining PLMN cell discovery information describing characteristics of the current active connection with information describing: (i) quality information of the current active connection over time; (ii) historical connection quality information of the discovered cells and geographically relevant cells, available to the UE via locally stored data and remotely archived data; (iii) historic bandwidth and data transfer rates; (iv) trending signal quality and strength; (v) speed of network transition; (vi) number of active cells; (vii) current quality information of discovered cells, made available via network discovery; (viii) preferring high-bandwidth radio access technologies; (ix) preferring low-traffic frequency bands; or (x) a combination thereof.

In an example, the processor-executable instructions stored thereon configured to cause the processor to maintain the secondary connected device communications and upload processes uninterrupted between the UE and the secondary user device can further include processor-executable instructions configured to cause the processor to preserve an active data connection of the secondary device by: (i) encapsulating data packets in the network traffic with additional data headers that direct network traffic to an intermediate server; and (ii) removing, at the intermediate server, the additional data headers to enable: (a) additional routing of the data packets; (b) re-ordering of the data packets when the data packets are received out-of-order; (c) consolidating different network source Internet Protocol (IP) addresses into one single outbound IP address; (d) repeating data transmission of dropped packets; or (e) a combination thereof.

In an example, provided is an apparatus configured to transmit continuous data to an endpoint computing device. The apparatus can include: (i) an electronic processor configured to execute a set of computer-executable instructions; (ii) a wireless cellular communications transceiver communicatively coupled to the electronic processor; and (iii) a memory communicatively coupled to the electronic processor and storing the set of computer-executable instructions. The set of computer-executable instructions can be configured to cause the electronic processor to: (i) perform discovery to establish a current active connection between the electronic processor and the endpoint computing device via a first cellular communications network; (ii) generate information describing candidate alternative cellular communications network connections, the information including a signal strength of an available, second alternative cellular communications network; (iii) transition the current active connection from the first cellular communications network to the second alternative cellular communications network; and (iv) maintain the transmission of continuous data to the endpoint computing device during the transitioning.

In an example, the set of computer-executable instructions can be further configured to cause the electronic processor to encapsulate transmitted data in packets, where each of the packets includes respective header data.

In an example, the connection to the endpoint computing device can include a server configured to use the respective header data to organize the packets enabling the endpoint computing device to receive the continuous data during the transition.

In an example, the server can be configured to use the respective header data to re-order one or more of the packets when at least one packet is received out of sequential order.

In an example, the performing the discovery further can include: (i) receiving, from a serving cell, information including: (a) a list of frequencies, and (b) a cellular communications network identifier; (ii) storing the received information in the memory; (iii) preparing information describing a summary of the received information; and (iv) transmitting the summary of the received information to the server.

In an example, the set of computer-executable instructions can be further configured to cause the electronic processor to generate information describing the current active connection by combining discovery information describing characteristics of the current active connection with information describing: (i) quality information of the current active connection over time; (ii) historical connection quality information of discovered cells and geographically relevant cells; (iii) historic bandwidth and data transfer rates; (iv) trending signal quality and strength; (v) speed of network transition; (vi) number of active cells; (vii) current quality information of discovered cells, made available via network discovery; (viii) preferring high-bandwidth radio access technologies; (ix) preferring low-traffic frequency bands; or (x) a combination thereof.

In an example, the maintaining the transmission of continuous data to the endpoint computing device during the transitioning can further include preserving an active data connection of the endpoint computing device by: (i) encapsulating data packets in the network traffic with data headers that direct network traffic to an intermediate server; and (ii) removing, at the intermediate server, the data headers to enable: (a) additional routing of the data packets; (b) re-ordering of the data packets when the data packets are received out-of-order; (c) consolidating different network source Internet Protocol (IP) addresses into one single outbound IP address; (d) repeating data transmission of dropped packets; or (e) a combination thereof.

In an example, the apparatus can further include an interface device communicatively coupled to the electronic processor and configured to receive electronic information describing an image.

In some embodiments, the systems and methods disclosed herein can provide services through a software as a service (Saas), a multi-tenant platform, or a combination thereof. The multi-tenant platform can provide access to multiple entities (e.g. tenants), each with a separate account and associated data storage. Each account can correspond to a user, set of users, an entity, a set or category of entities, a company, a business advisor, a set or category of users, an industry, an organization, or a combination thereof, as examples. Each account can access one or more services, a set of which are instantiated in their account, and which initiate at least a portion of one or more of the methods disclosed herein. Each account can access one or more services, a set of which are instantiated in their account, and which initiate at least a portion of one or more of the functions disclosed herein.

The terms “invention,” “the invention,” “this invention,” “the present invention,” “the present disclosure,” or “the disclosure” as used herein are intended to refer broadly to all subject matter disclosed by this document, the drawings (i.e. the Figures), and the claims. Statements containing these terms do not limit the subject matter disclosed or the meaning or scope of the claims. Embodiments covered by this disclosure are defined by the claims and not by this summary. This summary is a high-level overview of various examples and aspects of the disclosure and introduces some concepts that are further described in detail hereby. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Advantages of the provided systems, apparatuses, and methods will be apparent to one of ordinary skill in the art upon review of the detailed description and the included Figures.

While the exemplary embodiments provided hereby are susceptible to various modifications and alternative forms, specific embodiments are shown by way of example in the drawings and are described in detail herein. However, the exemplary or specific embodiments are not intended to be limited to the forms described. Rather, the disclosure covers all modifications, equivalents, and alternatives falling within the scope of the appended claims.

### BRIEF DESCRIPTION OF THE DRAWINGS

The accompanying drawings are presented to describe examples of the present teachings and are not limiting. Together with this following description, the drawings demonstrate and explain various principles of the present disclosure.

Embodiments of the disclosure are described with reference to the drawings, in which:

FIG. 1 depicts a wireless local area network generated by user equipment, providing access to a cellular network cell, in accordance with an embodiment of the disclosure.

FIG. 2 depicts a network condition for user equipment, where multiple public land mobile network cellular network cells are available and accessible to the user equipment for communication, in accordance with an embodiment of the disclosure.

FIG. 3 depicts a relationship between user equipment serving a secondary device, available network cells, and a role of a separate aggregation server prior to a communication endpoint.

FIG. 4 depicts an example method for providing stable wireless communication, in accordance with an embodiment of the disclosure.

FIG. 5 depicts a diagram of example components of a User Equipment device, in accordance with an embodiment of the disclosure.

FIG. 6 depicts another example method for providing stable wireless communication, in accordance with an embodiment of the disclosure.

FIG. 7 depicts an example network implementation of a system suitable for implementing examples of the disclosed subject matter.

FIG. 8 depicts an example diagram of an example computing device suitable for implementing examples of the disclosed subject matter.

FIG. 9 depicts an example diagram of an example system suitable for implementing examples of the disclosed subject matter.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Provided are example methods and apparatuses that can be used to automatically provide stable wireless communication. The provided methods and apparatuses address the aforementioned previously unaddressed and long-felt industry needs for methods and apparatus that improve upon conventional methods and conventional apparatus.

In examples, the present disclosure relates to wireless communications, and more specifically to systems and methods for maintaining uninterrupted data communications during network transitions, including inter-public land mobile network (PLMN) transitions. Multi-International Mobile Subscriber Identities (Multi-IMSI) Subscriber Identity Modules (SIM) store subscriber profiles from multiple mobile network operators (MNOs), allowing user equipment (UE) to capitalize on the strengths of local networks by connecting to the network with the strongest signal in each area of operation without need to swap physical SIM cards.

Multi-carrier SIMs are pre-programmed to select the home PLMN first; then, if the device is unable to connect to the home PLMN and set to automatically connect, it will either connect to the next available preferred network from an internally stored queue, or the network with the strongest signal. Once connected, that connection is maintained as long as the connection is available; but network conditions are often changing dynamically in response to surrounding conditions, such as weather, user traffic, and physical barriers. While the active connection may still be available, the updated conditions of that network may be reduced in comparison to other available networks. Current multi-carrier or multi-IMSI SIMs and UE do not account for this dynamic change.

The act of transitioning PLMN can disrupt active data uploads, especially large file uploads, challenging the utility of switching networks in the current state. Current techniques are systems utilizing multiple cellular modem connections to leverage the best available network at the time, increasing both hardware and data costs significantly. The provided methods and apparatuses address these problems, for example, by providing methods for uninterrupted large file uploads from a secondary device during inter-PLMN transitions, this disclosure introduces a mechanism for determining a best available PLMN for the secondary device's data communication and a method for maintaining the active communication process of the secondary device during inter-PLMN transitions.

In examples, the provided systems and methods can provide uninterrupted data communications by a secondary device communicating with user equipment via a local area network during inter-PLMN transitions. With the provided systems and methods, the UE is able to advantageously provide higher quality internet access for a secondary device over time as network conditions change, specifically suitable for large-volume data uploads, in a variety of physical locations and situations. The introduction of a multi-carrier SIM in conjunction with a separate intermediary server, through which communications can be directed by the user equipment, enables the user equipment to leverage available radio access technology serving cells (e.g. all) regardless of home network and optimize conditions of the available local area network over time.

The provided methods and apparatuses can, among other advantages, improve existing technological processes in the fields of electronics, computer-readable media, and computer engineering. For example, the provided methods and apparatuses particularly improve the technological process of providing stable wireless communication by utilizing the provided techniques, and thereby provide advantages over conventional techniques.

In non-limiting examples, the provided apparatus can be a device that connects to a best cellular network available in an area through an eSIM card and combines the signal with nearby Wi-Fi connections, to provide dedicated internet for a camera or device to upload files storing stills and videos to the cloud. The provided apparatus can evaluate bandwidth and stability of the available connections before selecting a preferred connection to maximize network stability. This can be overridden by a user if desired.

In non-limiting examples, the provided apparatus then broadcasts a preconfigured wireless local network, that the user can connect to for stable internet connectivity. This stable connectivity (a combination of mobile carrier and local Wi-Fi) enables the user to seamlessly upload their photo and video content. The provided apparatus can be powered via a USB-C connector, and can be powered directly via a wall outlet or a camera connection. The provided apparatus can be attached to a camera or other support via a standard ¼″ tripod screw mount, and can be mounted directly to a camera.

In non-limiting examples, the provided apparatus settings can be configured via a user interface, including preferred cellular carrier selection, and local Wi-Fi selection. Users must authenticate prior to modifying settings of the provided apparatus. Additionally, businesses can control these same settings of multiple provided apparatus remotely via an online management portal in addition to enterprise settings such as data upload limits.

In non-limiting examples, the provided apparatus can utilize a custom Linux distribution and custom software to (1) evaluate available connectivity to select the wireless connection with the most bandwidth and stability, (2) connect wirelessly to that stable connection, (3) broadcast a local area network (a.k.a. Hotspot) for a wireless connection, (4) host a local server and webpage that, through secure user authentication, enables a user to modify specific settings on the provided apparatus, such as preferred mobile carrier and local Wi-Fi settings.

In non-limiting examples, Film and TV production companies, smaller hobbyists, and wedding photographers can use the provided apparatus to connect a camera to the internet so the user can, in real-time, upload files storing photos and videos to a cloud computing device, e.g. to display the images or footage. The provided apparatus also enable post-production work on the images or footage as soon as the images or footage is uploaded, to improve upon a quality and timeliness of a final product delivery. This can include individuals like YouTube content creators who work with editing teams, or full-scale production companies. Additionally, the provided apparatus can be utilized for wider network connectivity (such as portable hotspots).

In non-limiting examples, the provided methods and apparatus improve on conventional techniques by providing a hybrid device, especially for the camera industry. In non-limiting examples, the provided apparatus can intelligently combine eSIM connectivity with potential local wireless network connectivity to offer a more stable connection over conventional devices. The provided apparatus offers enterprise-level control of devices as well as at the individual consumer-level. The provided apparatus can be an all-in-one lightweight and portable device that can readily connect to and can be powered by a standard digital camera, a mirrorless camera, or both.

In non-limiting examples, users can use the provided apparatus to connect to the Internet, such as a user device can use a regular mobile hotspot or Wi-Fi network. Individuals whose phones or cellular carriers do not support eSIM technology can use the provided apparatus while traveling to connect their various internet enabled devices.

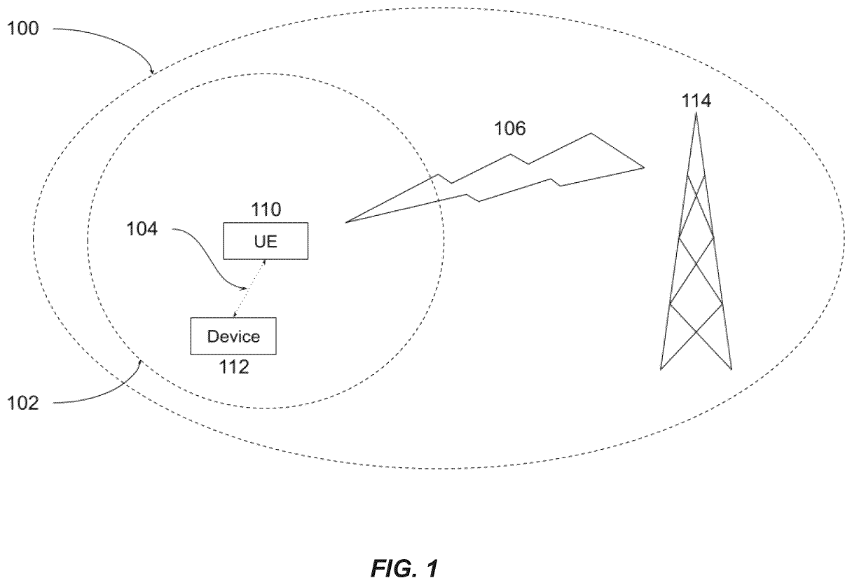

FIG. 1 depicts a local area network 102 providing a secure communication device 104 between user equipment (UE) 110 and secondary user device 112. FIG. 1 further illustrates communication 106 between the UE 110 and a network serving cell 114, availability of which is represented by the cell's serving area 100, which can be associated with an anchor cell, macro cell or primary cell.

In one aspect, this enables secondary devices currently lacking the means for cellular communication access to the mobile advantages inherent with cellular communications. Secondary devices are not required to contain technologies required for standardized communication protocols with cellular serving cells, and instead are able to rely on existing wireless and wired local area connection communication protocols.

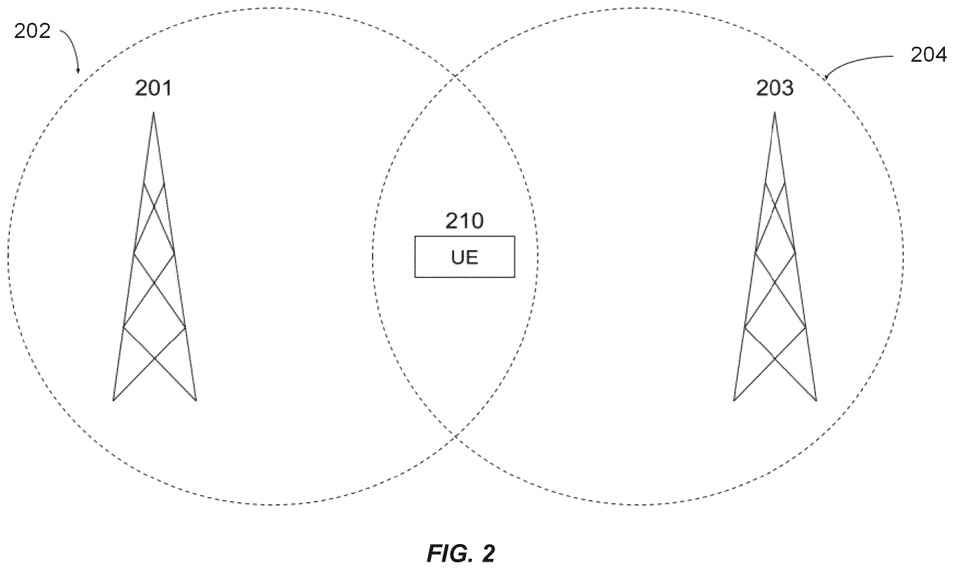

FIG. 2 illustrates a typical network situation, where a UE 210 is within a range of a serving cell 201 belonging to Public Mobile Land Network (PLMN) 202 and serving cell 203 belonging to PLMN 204. As shown in FIG. 2, multi-carrier subscriber identity modules (SIM) allow the UE 210 to maintain a contract with the organization maintaining PLMN 202 and PLMN 204 simultaneously, meaning the UE is authorized to use both available networks.

Multi-carrier and multi-IMSI SIMs can increase a total number of available cellular technologies and individual serving cells the UE is able and contracted to communicate with, enabling global coverage without direct SIM modification. This technology differs from the similar Embedded Universal Integrated Circuit Card (eUICC) SIM, which allows over-the-air (OTA) switching of Mobile Network Operators (MNOs) and device provisioning but requires multiple profiles and the switching of profiles to transition connection between multiple carriers.

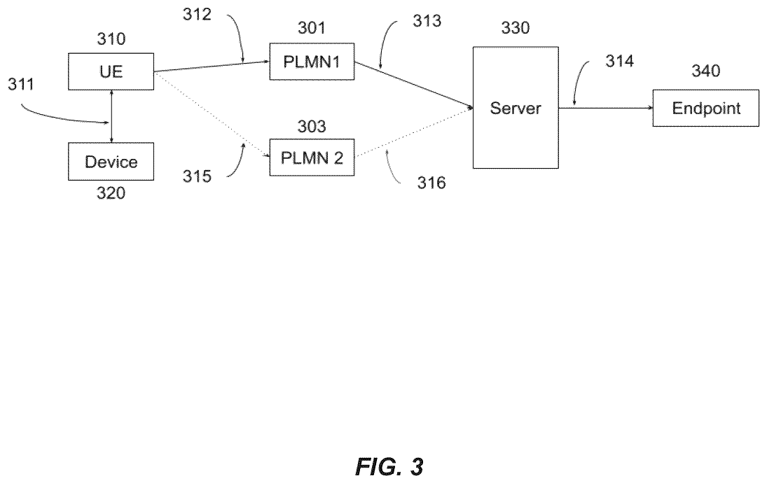

FIG. 3 illustrates a possible data communication negotiation between a UE 310, a PLMN serving cell for PLMN #1 301 and a PLMN serving cell for PLMN #2 303 during a network optimization transition. FIG. 3 demonstrates how communication from a secondary device 320 is sent to the UE 310 via a local area network communication device 311, then sent to the currently connected PLMN #1 cell 301 via cellular communication 312. This communication is then sent via wireless or wired communication route 313 to a remote server 330 instead of directly to the destination endpoint 340, where the remote server can perform additional processing and aggregation on communications from the UE comprising combining and transmitting them via wired or wireless communication route 314 them to the final destination endpoint 340. While this communication is taking place, the UE 310 is aware of a second potential communication path 315 with PLMN #2 303, which is also able to communicate via wireless or wired communication route 316 with the intermediary server 330. At any time, the UE 310 is able to switch communication from PLMN #1 301 to PLMN #2 303.

This example illustrates the UE's 310 ability to transition between communicating directly with the serving cell for PLMN #1 301 and PLMN #2 303, highlighting the role the intermediary server 330 plays in this transition. The secondary device 320 and endpoint 340 need not be made aware of the network transition, requiring no additional special handling or programmatic logic. The communications from the secondary device 320 are able to reach the desired endpoint 340 without disruption regardless of which PLMN the UE 310 is communicating with at any given moment.

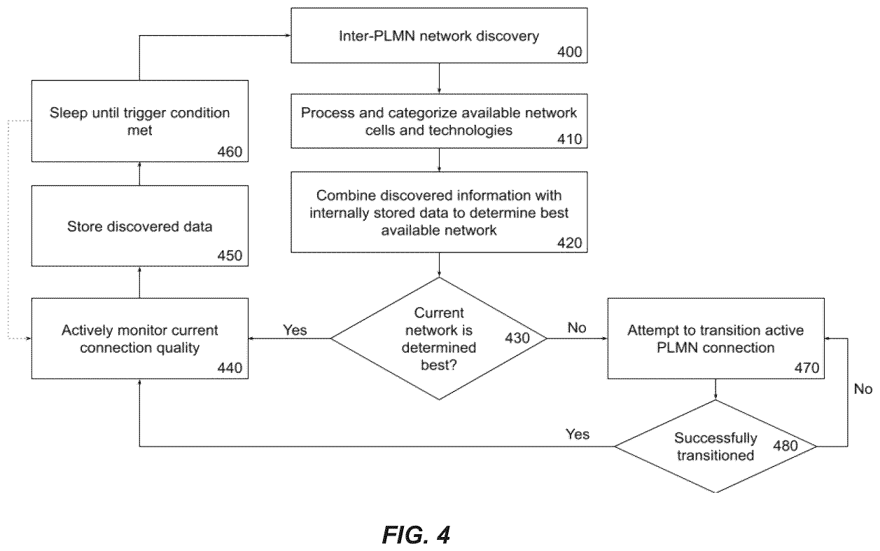

FIG. 4 illustrates an example process according to another embodiment of the present disclosure. As shown in FIG. 4, the process starts at block 400 and proceeds to block 410, where the inter-frequency and inter-PLMN network discovery scan information is processed and categorized based on the available network cells and technologies they support, including the Reference Signal Received Quality (RSRQ), a measurement of the quality of the received signal from a cellular tower that takes into account interference information. Other events could be involved in the network discovery step for block 400 and the present disclosure is not limited to the above.

The process then proceeds to block 410, where the UE internally processes and categorizes the information discovered during block 400. This includes storing the received scan information locally for current and future optimization processes. Information may be stored discretely based on the individual network cell identifying information. Information about network cells that the UE is not currently compatible with or contracted with may be discarded.

The process then proceeds to block 420, where the UE combines the processed information from block 410 with any previously processed and stored information about the surrounding serving cells. This combined information is used to programmatically determine the probable strongest and most stable network connection available to the UE at the present moment. Each cell is given a generated score based on factors including but not limited to current and historical RSRQ, historical data speeds, and latency.

The process then proceeds to block 430, where the selected optimized network is compared against the currently connected network. In the case where the currently connected network is determined to still be the optimum network, the process proceeds to block 440 where the UE continually monitors quality information for the current connection, including but not limited to: Reference Signals Received Power (RSRP); RSRQ; Unique cell identification; MNO; Bandwidth; or a combination thereof.

The process proceeds to block 450, where the measured quality information is stored for later use and analysis. This information may be stored locally in long-term storage or uploaded to a remote database.

The process then proceeds to block 460, which represents a sleep state or holding state until specific criteria are met. Example trigger criteria may include a certain amount of time passing or the currently active connection's measured quality dropping below a desired threshold determined by the system. While the trigger criteria are not met, the process continues actively monitoring and storing the current connection's quality information as described in block 440 and 450, represented on the figure as a dotted line. When the trigger criteria is met, the process repeats from the beginning of the process starting at block 400 again.

In the case where the selected optimized network is not the current network, the process proceeds from block 430 to block 470 where the UE disconnects from the current active PLMN and attempts to connect to the determined optimum network.

In this example, the process then automatically proceeds to block 480 as a control step where the current active connection is then checked to ensure internet access is maintained. If the connection attempt was unsuccessful, the UE reverts back to block 470 and attempts to connect again. Once the connection attempt is successful, the process proceeds to block 440 as described previously.

The method and process described above can be used by any sufficient computing device configured to perform the steps herein. It will be appreciated that the process is illustrative and that variations and modifications are possible. Steps described as sequential may be executed in parallel, order of steps may be varied, and steps may be modified, combined, added or omitted.

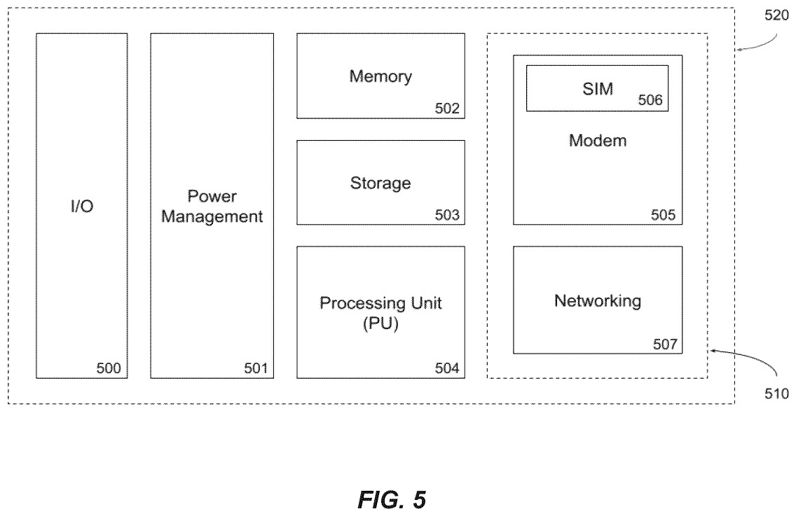

FIG. 5 depicts an example computing device 520. As shown in FIG. 5, communication sub-system 510 includes at least one networking device 507 such as a wireless network interface controller (WNIC), and/or an Ethernet or equivalent local area network technology, able to communicate with external devices on behalf of the device. Communication sub-system 510 can also include a cellular modem 505 within which resides a multi-carrier SIM 506.

A processing unit 504 can be configured to execute programmable logic, which may be stored, along with data, in memory 502 and storage 503 units. The memory 502 can be a tangible, non-transitory computer readable storage medium such as optical, magnetic, flash drive, hard drive, or other memory. Alternatively, or in addition to memory 502, the device 520 can access data or programmable logic from an external storage medium, for example through communications sub-systems 510.

The device 520 can also include input/output 500 interfaces such as, but not limited to, high-definition multimedia interface (HDMI), Universal Serial Bus (USB-A, USB-C); and a power and management subsystem 501 sufficient to power the device throughout a typical use period. One such example of a power solution would be a rechargeable battery sufficient to supply the appropriate voltage and amperage required for 4-hours of continuous use.

In an embodiment, the UE can include a multi-IMSI SIM operatively coupled to a LTE/5G modem, a quad-core ARM-based processor operating at 2.0-2.5 GHZ, and a minimum of 4 GB LPDDR4 memory. The UE can execute a network assessment program to periodically measure RSRP, RSRQ, uplink throughput, downlink throughput, latency, and jitter. Measurements can be stored in a ring buffer of at least 60 seconds duration.

A PLMN selection engine, implemented as a software module in C or equivalent, can calculate a weighted score for each candidate PLMN. An exemplary scoring algorithm is as follows:

$$Weighted Score = ( 0.4 * normalized\_RSRQ ) + ( 0.2 * normalized\_uplink \_latency \_inverse ) * ( 0.1 * normalized\_jitter \_inverse ) * ( 0.3 * normalized\_uplink \_throughput )$$

Normalization maps raw measurements into a 0-1 range based on empirically derived maxima and minima.

Upon determining that a candidate PLMN's score exceeds the currently connected PLMN's score by more than 10% and ensuring a minimum time threshold of 5 minutes has elapsed since the last network transition, a transition process is triggered. The transition includes establishing a control plane connection to the target PLMN after deactivating the active data tunnel to the source PLMN.

To prevent data communication disruptions from this transition, an intermediary server, implemented either as a low-latency edge node (<20 ms RTT) or as a cloud-hosted virtual machine, is responsible for:
1) Receiving packet streams from both source and target PLMNs pre- and post-transition.
2) Re-sequencing packets using sequence number fields in TCP/UDP headers.
3) Removing duplicate packets.
4) Forwarding the reassembled packet stream to the destination host with a maximum allowable jitter of 5 ms.

The system optionally can encapsulate data streams to preserve data integrity. In an embodiment, the intermediary server can be integrated directly into the UE firmware, eliminating external routing in low-bandwidth scenarios.

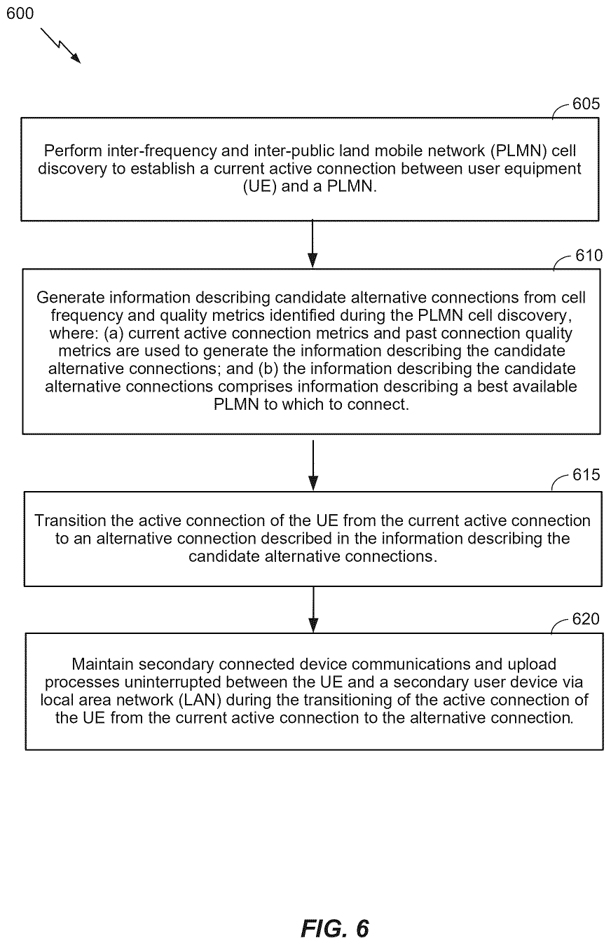

FIG. 6 depicts a block diagram of a method 600 for automatically providing a stable Internet connection, in accordance with an embodiment of the disclosure. The method 600 provides a broad overview of some of the techniques described in further detail herein.

In an embodiment, the method 600 can be implemented in a form of a set of computer-executable instructions. In examples, computer-executable instructions can include artificial intelligence algorithms, trained artificial intelligence models, routines, programs, objects, components, data structures, procedures, operations, modules, functions, or a combination thereof, as non-limiting examples. Such computer-executable instructions can be executed by one or more programmed processors or co-processors, such as those described hereby.

The order in which the method 600 is described is not intended to be construed as a limitation, and any number of the described features can be combined in any order to implement the method 600 or alternate methods for automatically generating and using at least a portion of a machine configured to provide a stable Internet connection. Additionally, individual features can be omitted, as is practicable, from the method 600 without departing from the scope of the subject matter described herein. Furthermore, the method 600 can be implemented in any suitable hardware, software, firmware, or a combination thereof, such as the apparatus described hereby.

As shown in FIG. 6, at step 605, one or more of the devices described herein can perform inter-frequency and inter-public land mobile network cell discovery to establish a current active connection between the UE and a PLMN.

In examples, the performing the PLMN cell discovery can further include receiving, from a serving cell, information comprising: a list of frequencies, a reference signal received quality (RSRQ), a PLMN identifier (ID), or a combination thereof.

In examples, the performing the PLMN cell discovery can further include storing the received information in a UE memory.

In examples, the performing the PLMN cell discovery can further include preparing information describing a summary of the received information.

In examples, the performing the PLMN cell discovery can further include transmitting the summary of the received information to a remote server.

In examples, the method 600 can include generating information describing the current active connection, for example, by combining PLMN cell discovery information describing characteristics of the current active connection with information describing:
1) quality information of the current active connection over time;
2) historical connection quality information of the discovered cells and geographically relevant cells, available to the UE via locally stored data and remotely archived data;
3) historic bandwidth and data transfer rates;
4) trending signal quality and strength;
5) speed of network transition;
6) number of active cells;
7) current quality information of discovered cells, made available via network discovery;
8) preferring high-bandwidth radio access technologies;
9) preferring low-traffic frequency bands; or
10) a combination thereof.

At step 610, one or more of the devices described herein can generate information describing candidate alternative connections from cell frequency and quality metrics identified during the PLMN cell discovery. In examples, current active connection metrics and past connection quality metrics can be used to generate the information describing the candidate alternative connections. In examples, the information describing the candidate alternative connections can include information describing a best available PLMN to which to connect.

At step 615, one or more of the devices described herein can transition the active connection of the UE from the current active connection to an alternative connection described in the information describing the candidate alternative connections.

At step 620, one or more of the devices described herein can maintain secondary connected device communications and upload processes uninterrupted between the UE and a secondary user device (e.g. a camera) via a local area network (LAN) during the transitioning of the active connection of the UE from the current active connection to the alternative connection.

In some examples, the maintaining the secondary connected device communications and upload processes uninterrupted between the UE and the secondary user device can further include preserving an active data connection of the secondary device by (i) encapsulating data packets in the network traffic with additional data headers that direct network traffic to an intermediate server; and (ii) removing, at the intermediate server, the additional data headers. This technique can enable additional routing of the data packets; re-ordering of the data packets when the data packets are received out-of-order; consolidating different network source Internet Protocol (IP) addresses into one single outbound IP address; repeating data transmission of dropped packets; or a combination thereof.

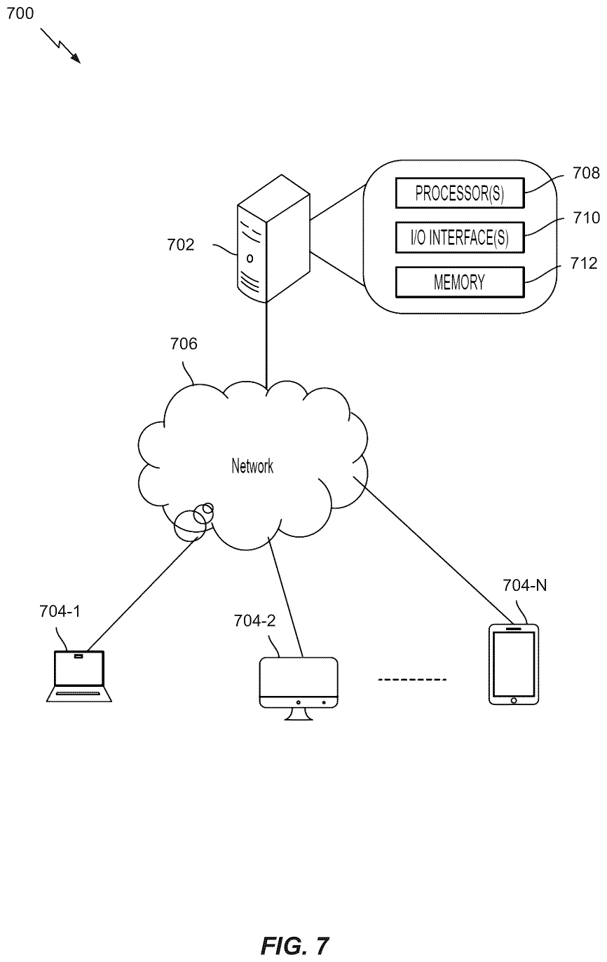

FIG. 7 depicts a network implementation 700 of a system 702 suitable for implementing examples of the disclosed subject matter. In examples, one or more users can access the system 702 through one or more user devices 704-1, 704-2 . . . 704-N, collectively referred to as user devices 704, hereinafter, or applications residing on the user devices 704.

Although the disclosure is explained considering that the system 702 is implemented on a server, the system 702 can be implemented in other forms of a computing device or system, such as a laptop computer, user equipment, a desktop computer, a notebook, a workstation, a virtual environment, a mainframe computer, a server, a network server, or a cloud-based computing environment. It will be understood that the system 702 can be accessed by multiple users through one or more user devices 704-1, 704-2 . . . 704-N.

In one implementation, the system 702 can comprise a cloud-based computing environment in which the user can operate individual computing systems configured to execute remotely located applications. Examples of the user devices 704 can include, but are not limited to, a portable computer, a personal digital assistant, a handheld device, a workstation, or a combination thereof. The user devices 704 can be communicatively coupled to the system 702 through a network 706.

In one implementation, the network 706 can be a wireless network, a wired network, or a combination thereof. The network 706 can be implemented as one of several different types of networks, including but not limited to an intranet, local area network (LAN), wide area network (WAN), the Internet, or a combination thereof. The network 706 can be a dedicated network or a shared network. A shared network can be an association of different types of networks that use a variety of protocols, for example, Hypertext Transfer Protocol (HTTP), Transmission Control Protocol/Internet Protocol (TCP/IP), or Wireless Application Protocol (WAP) to communicate with one another. Further, the network 706 can include a variety of network devices, including routers, bridges, servers, computing devices, storage devices, or a combination thereof.

In an embodiment, system 702 can include at least one processor 708, an input/output (I/O) interface 710, and a memory 712. The processor 708 can be implemented as one or more microprocessors, microcomputers, microcontrollers, digital signal processors, Central Processing Units (CPUs), state machines, logic circuitries, devices that manipulate signals based on operational instructions, or a combination thereof. Among other capabilities, the at least one processor 708 can be configured to fetch and execute computer-readable instructions stored in the memory 712.

The in/out (I/O) interface 710 can include software and hardware interfaces, for example, a web interface, a graphical user interface (GUI, UI), and the like. The I/O interface 710 can allow the system 702 to interact with the user directly or through at least one of the client devices 704-1 to 704-N. Further, the I/O interface 710 can enable the system 702 to communicate with other computing devices, such as web servers and external data servers (not shown). The I/O interface 710 can facilitate communications and data transfer within a wide variety of networks and protocol types, including wired networks (for example, Local Area Network or cable) and wireless networks (such as wireless local area network, a cellular network, or a satellite network). The I/O interface 710 can include one or more ports for connecting a number of devices to one another or to another server.

The memory 712 can include a computer-readable medium or computer program product. Non-limiting examples include volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 712 can include routines, programs, objects, instructions, modules, components, or data structures which perform particular tasks or implement particular abstract data types. The memory 712 can include programs or instructions that supplement applications and functions of the system 702. In an embodiment, the memory 712 can serve as a repository for storing data processed, received, generated or a combination thereof by one or more programs or coded instructions.

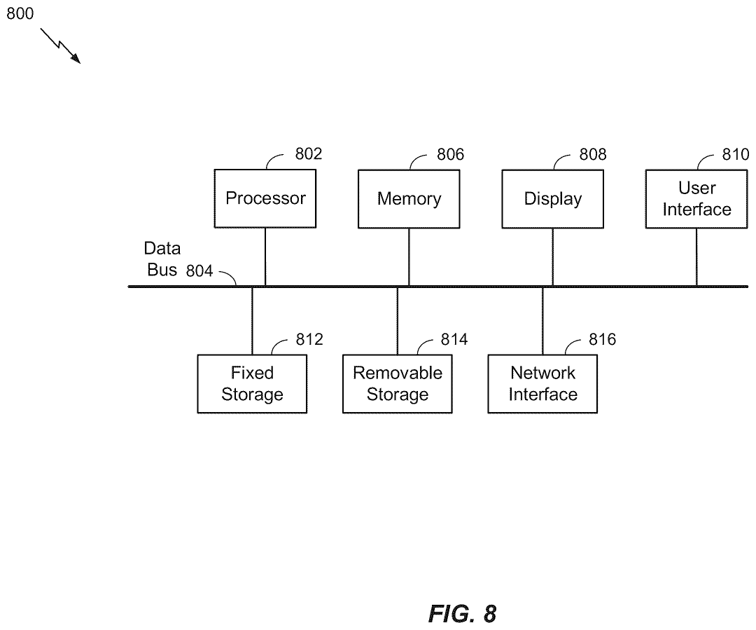

FIG. 8 depicts an example diagram of an example computing device 800 suitable for implementing examples of the disclosed subject matter. For example, at least a portion of the computing device 800 can be suitable for use as a component part of the system 702, at least one of the user devices 704-1 to 704-N, or a combination thereof. In another example, at least a portion of the computing device 800 can be coupled to the network 706.

In examples, a process management machine can include at least a portion of the example computing device 800, at least a portion of the system 702, or both, configured with computer-executable instructions to perform at least a portion of a technique described hereby, where the computer-executable instructions can be stored on a non-transitory computer-readable data storage device, a non-transitory computer-readable medium, or both.

In examples, aspects of the computing device 800 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented in, and used with, hardware devices, computer network devices, the like, or a combination thereof. The configuration depicted in FIG. 8 is an illustrative example and is not limiting.

As shown in FIG. 8, the computing device 800 can include a processor 802, a data bus 804, a memory 806, a display 808, a user interface 810, a fixed storage device 812, a removable storage device 814, a network interface 816, the like, or a combination thereof. These elements are described in further detail herein.

The processor 802 can be a hardware-implemented processing unit configured to control at least a portion of operation of the computing device 800. The processor 802 can perform logical and arithmetic operations based on processor-executable instructions stored within the memory 806. The processor 802 can be configured to execute instructions that cause the processor 802 to initiate at least a part of a method described hereby. In an example, the processor 802 can interpret instructions stored in the memory 806 to initiate at least a part of a method described hereby. In an example, the processor 802 can execute instructions stored in the memory 806 to initiate at least a part of a method described hereby. The processor 802 can be configured to execute instructions that cause the processor 802 to perform at least a part of a method described hereby. In an example, the processor 802 can interpret instructions stored in the memory 806 to perform at least a part of a method described hereby. In an example, the processor 802 can execute instructions stored in the memory 806 to perform at least a part of a method described hereby. The instructions, when executed by the processor 802, can transform the processor 802 into a special-purpose processor that causes the processor to perform limited functions including at least a part of a function described hereby. The processor 802 can also be referred to as a central processing unit (CPU), a special-purpose processor (e.g. a non-generic processor), or both.

In some examples, the computing device 800 can implement artificial intelligence techniques (e.g. using a Convolutional Neural Network (CNN), etc.) to collect information, process information, or both. In some examples, information stored in an information storage device of the computing device 800 can be transferred to another computing device.

The processor 802 can comprise or be a component of a physical processing system implemented with one or more processors. In some examples, the processor 802 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a suitable physical device configured to manipulate information (e.g., calculating, logical operations, the like, or a combination thereof), the like, or a combination thereof.

The data bus 804 can couple components of the computing device 800. The data bus 804 can enable information communication between the processor 802 and one or more components coupled to the processor 802. In some examples, the data bus 804 can include a data bus, a power bus, a control signal bus, a status signal bus, the like, or a combination thereof. In an example, the components of the computing device 800 can be communicatively coupled together to communicate with each other using a different suitable mechanism.

The memory 806 generally represents any type or form of volatile storage device, non-volatile storage device, medium, the like, or a combination thereof. The memory 806 can store data (e.g. a database), processor-readable instructions, the like, or a combination thereof. In an example, the memory 806 can store data, load data, maintain data, or a combination thereof. In an example, the memory 806 can store processor-readable instructions, load processor-readable instructions, maintain processor-readable instructions, or a combination thereof. In some embodiments, the memory 806 can store computer-readable instructions configured to cause a processor (e.g. the processor 802) to initiate performing at least a portion of a method described hereby. In some embodiments, the memory 806 can store computer-readable instructions configured to cause a processor (e.g. the processor 802) to perform at least a portion of a method described hereby. The memory 806 can be a main memory configured to store an operating system, an application program, the like, or a combination thereof. The memory 806 can store a basic input-output system (BIOS) which can control basic hardware operation such as interaction of the processor 802 with peripheral components. The memory 806 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 806 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, a database, the like, or a combination thereof) and is configured to provide the information to the processor 802.

The display 808 (i.e. a user display device) can include a component configured to visually convey information to a user of the computing device 800. In examples, the display 808 can be a video display screen, such as a light-emitting diode (LED) screen, a touch screen, or both. In examples, the display 808 can display, such as via a user interface, information described herein, information produced by at least a portion of a method described herein, or both. In examples, the display 808 can display a graphical user interface (GUI).

The user interface 810 can include user devices such as a switch, a computer mouse, a trackpad, a keypad, a keyboard, a touch screen, a microphone, a speaker, an audio production device, a camera, a jack for coupling the computing device to an audio production device, the like, or a combination thereof. The user interface 810 can optionally include a user interface controller. The user interface 810 can include a component configured to convey information to a user of the computing device 800, a component configured to receive information from the user of the computing device 800, or both. In examples, the user interface 810 can include the display 808.

The fixed storage device 812 can include one or more hard drive, flash storage device, the like, or a combination thereof. The fixed storage device 812 can be an information storage device (e.g. storing a database) that is not configured to be removed during use. The fixed storage device 812 can optionally include a fixed storage device controller. The fixed storage device 812 can be integral with the computing device 800 or can be separate and accessed through an interface.

The removable storage device 814 can be integrated with the computing device 800 or can be separated and accessed through other interfaces. The removable storage device 814 can be an information storage device (e.g. storing a database) that is configured to be removed during use, such as a memory card, a jump drive, a flash storage device, an optical disk, the like, or a combination thereof. The removable storage device 814 can optionally include a removable storage device controller. The removable storage device 814 can be integrated with the computing device 800 or can be separate and accessed through an interface.

In examples, a computer-readable storage medium such as one or more of the memory 806, the fixed storage device 812, the removable storage device 814, a remote storage location, the like, or a combination thereof can store non-transitory computer-executable instructions configured to cause a processor (e.g. the processor 802) to implement at least a portion of an aspect of the present disclosure.

The network interface 816 can couple the processor 802 (e.g. via the data bus 804) to a network (e.g. network 706 in FIG. 7) and enable exchanging information between the processor 802 and the network. In some examples, the network interface 816 can couple the processor 802 (e.g. via the data bus 804) to the network and enable exchanging information between the processor 802 and another computing device. For example, the network interface 816 can enable the processor 802 to communicate with one or more other network devices. The network interface 816 can couple to the network using any suitable technique and any suitable protocol. In some examples, the network interface 816 can include a data bus, a power bus, a control signal bus, a status signal bus, the like, or a combination thereof. Example techniques and protocols the network interface 816 can be configured to implement include digital cellular telephone, WiFi™, Bluetooth®, near-field communications (NFC), the like, or a combination thereof.

The network can couple the processor 802 to one or more other network devices (e.g. user devices 704-1, 704-2 . . . 704-N in FIG. 7). In some examples, the network can enable exchange of information between the processor 802 and the one or more other network devices. In some examples, the network can enable exchange of information between the processor 802 and another computing device. The network can include one or more private networks, local networks, wide-area networks, the Internet, other communication networks, the like, or a combination thereof. In some examples, the network can be a wired network, a wireless network, an optical network, the like, or a combination thereof.

In some embodiments, the network device can store computer-readable instructions configured to cause a processor (e.g. the processor 802) to initiate performing at least a portion of a method described hereby. In an example, the one or more other network devices can store non-transitory computer-executable instructions configured to cause a processor (e.g. the processor 802) to implement at least an aspect of the present disclosure. The non-transitory computer-executable instructions can be received by the processor 802 and implemented using at least a portion of techniques described hereby. In another example, information described hereby can be stored in the fixed storage device 812, the removable storage device 814, the network device, the like, or a combination thereof.

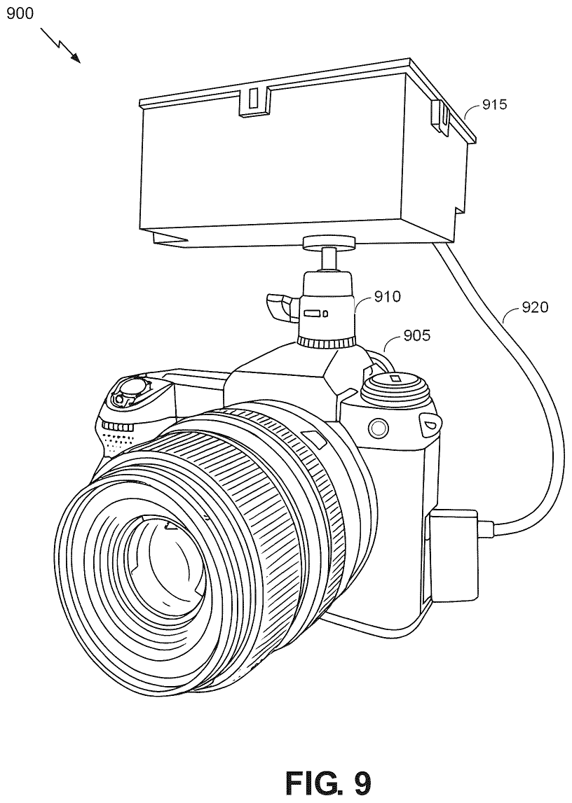

FIG. 9 depicts an example diagram of an example system 900 suitable for implementing examples of the disclosed subject matter.

The example system 900 can include a camera 905, a mounting device 910, user equipment 915, and an electrical cable 920.

The camera 905 is a non-limiting example of the secondary user device 112, the secondary device 320, or a combination thereof.

The mounting device 910 can be a tangible device configured to mechanically fasten the user equipment 915 to the camera 905. The mounting device 910 can include at least one of the following devices configured to fasten the mounting device 910 to the user equipment 915, the camera 905, or both: a camera shoe, a threaded post (e.g. having a ¼-20 thread), a quick connect plate, a ball head, a tripod head, a suction cup, a clamp, or a combination thereof.

The user equipment 915 is a non-limiting example of the user equipment 110, the user equipment 210, the user equipment 310, or a combination thereof.

The electrical cable 920 is a non-limiting example of the secure communication device 104, the local area network communication device 311, or a combination thereof. The electrical cable 920 can transfer electrical power between the user equipment 915 and the camera 905. The electrical cable 920 can transfer electronic communications between the user equipment 915 and the camera 905. Although electrical cable 920 is shown in FIG. 9, in other embodiments wireless communications (e.g., Bluetooth, WiFi or other suitable wireless communication protocols) may be used.

In examples, at least a portion of the computing device 800 can be suitable for use as a component part of the user equipment 110, the user equipment 210, the user equipment 310, the user equipment 915, or a combination thereof.

In examples, at least a portion of the computing device 800 can be suitable for use as a component part of the secondary user device 112, the secondary device 320, the camera 905, or a combination thereof.

In examples, at least a portion of the computing device 520 can be suitable for use as a component part of the user equipment 110, the user equipment 210, the user equipment 310, the user equipment 915, or a combination thereof.

In examples, at least a portion of the computing device 520 can be suitable for use as a component part of the secondary user device 112, the secondary device 320, the camera 905, or a combination thereof.

Exemplary embodiments discussed herein can provide certain advantages. These advantages can include those provided by the disclosed features.

Although systems and methods for automatically providing stable wireless communication are described hereby in a language specific to structural features and/or methods, the appended claims are not necessarily limited to the specific features or methods described. Rather, the specific features and methods are disclosed as examples of implementations for providing stable wireless communication.

One or more embodiments of the disclosed subject matter are described herein with specificity to meet statutory requirements, but this description does not limit the scope of the claims. The claimed subject matter can be embodied in other ways, can include different elements or steps, and can be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure can be practiced. The disclosure may, however, be embodied in different forms and should not be construed as limited to the embodiments set forth herein, rather, these embodiments are provided so that this disclosure will satisfy the statutory requirements and convey the scope of the disclosure to those skilled in the art.

Among others, the subject matter of the disclosure can be embodied in whole or in part as a system, as one or more methods, or as one or more devices. Embodiments can take the form of a hardware implemented embodiment, a software implemented embodiment, or an embodiment combining software and hardware aspects. For example, in some embodiments, one or more of the operations, functions, processes, or methods disclosed and/or described herein can be implemented by one or more suitable processing elements (such as a processor, co-processor, microprocessor, Central Processing Unit, Graphics Processing Unit, Tensor Processing Unit, Quantum Processing Unit, controller, or a combination thereof, as non-limiting examples) that is part of a client device, server, network element, remote platform (such as a Software as a Service (Saas) platform), an “in the cloud” service, or other form of computing or data processing system, device, or platform.

The processing element or elements can be programmed with a set of executable instructions (e.g. software instructions), where the instructions can be stored on (or in) one or more suitable non-transitory computer-readable data storage elements, one or more suitable non-transitory computer-readable media, or both. In an embodiment, the set of instructions can be conveyed to a user through a transfer of instructions or an application that executes a set of instructions (such as over a network, e.g., the Internet). In an embodiment, a set of instructions or an application can be utilized by an end-user through access to a SaaS platform or a service provided through such a platform.

In an embodiment, the systems and methods disclosed herein can provide services through a SaaS or multi-tenant platform. The platform provides access to multiple entities, each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods, features, or functions disclosed herein.

In an embodiment, one or more of the operations, functions, processes, features, or methods disclosed herein can be implemented by a specialized form of hardware, such as a programmable gate array, application specific integrated circuit (ASIC), or the like. An embodiment of the disclosure can be implemented in the form of an application, a sub-routine that is part of a larger application, a “plug-in,” an extension to the functionality of a data processing system or platform, or other suitable form. This description is, therefore, not to be taken in a limiting sense.

It should be understood that the present invention as described herein can be implemented in a form of control logic using computer software in a modular or integrated manner. Based on the disclosure and teachings provided herein, a person of ordinary skill in the art will know and appreciate other techniques to implement an embodiment of the disclosure using hardware or a combination of hardware and software.

Any of the software components, processes or functions described in this application can be implemented as software code to be executed by a processor using any suitable computer language such as at least one of Python, Java, Javascript, C, C++, C#(“C Sharp”), Type Script, Java Script, Platform Client Application Programming Interface (API) Script, or Perl using procedural, functional, object-oriented, or other techniques. The software code can be stored as a series of instructions, or commands in (or on) a non-transitory computer-readable medium, such as a random-access memory (RAM), a read only memory (ROM), a magnetic medium such as a hard-drive, a jump drive, an optical medium such as a CD-ROM, or a combination thereof. In this context, a non-transitory computer-readable medium is almost any medium suitable for the storage of data or an instruction set aside from a transitory waveform. Any such computer readable medium can reside on or within a single computational apparatus and can be present on or within different computational apparatuses within a system or network.

The systems and methods described herein are directed to improvements in computer-readable media arts, and improve the functioning of computer-readable media and computers executing instructions stored on the computer-readable media. For example, the provided methods and apparatuses particularly improve the functioning of computer-readable media storing instructions that, when executed by a processor, provide a stable Internet connection.

According to one example implementation, the term processing element or processor, as used herein, can be a central processing unit (CPU), or conceptualized as a CPU (such as a virtual machine). In this example implementation, the CPU or a device in which the CPU is incorporated can be at least one of coupled, connected, or in communication with one or more peripheral devices, such as the user display device. In another example implementation, the processing element or processor can be incorporated into a mobile computing device, such as a smartphone, a camera, user equipment, a tablet computer, or a combination thereof.

The non-transitory computer-readable storage medium referred to herein can include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium can include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. In some embodiments, one or more of the blocks, or stages or steps may not necessarily need to be performed in the order presented or may not necessarily need to be performed.

The computer-executable program instructions described herein can be loaded onto a special purpose computer, a processor, or other programmable data processing apparatus to produce a specific example of a machine, such that the instructions executed by the computer, processor, or other programmable data processing apparatus create means for implementing one or more of the functions, operations, processes, or methods described herein. In examples, these computer program instructions can also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein. In examples, these computer program instructions can also be stored in a computer-readable memory that can direct a computer or other programmable data processing apparatus to function in a specific manner, such that the instructions stored in the computer-readable memory produce an article of manufacture storing instructions that implement, initiate, or both, at least a portion of one or more of the functions, operations, processes, methods or a combination thereof, as described hereby. Descriptions herein to information describing an aspect can describe digital information (e.g., non-transitory machine-processable digital electronic information) describing the aspect. In an example, a feature disclosed hereby can be described by digital information describing the feature.

The systems and methods described herein are directed to improvements to computer functionality, and improve the functioning of computers. For example, the provided methods and apparatuses particularly improve the functioning of computers that provide stable wireless communication.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation. Unless described otherwise herein, the examples provided hereby are nonlimiting.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims when they have structural elements, functional elements, or both that do not differ from the literal language of the claims, or if they include structural elements, functional elements, or both with insubstantial differences from the literal language of the claims.

The use of the terms “a,” “an,” “the,” and similar referents in the specification and in the following claims are to be construed to cover both the singular and the plural, unless otherwise indicated herein or clearly contradicted by context. The singular portends the plural, where practicable. The terms “having,” “including,” “containing,” and similar referents in the specification and in the claims are to be construed as open-ended terms (e.g. meaning “including, but not limited to,”) unless otherwise noted. All methods described herein can be performed in any suitable order unless otherwise indicated herein or clearly contradicted by context. The use of all examples, or exemplary language (e.g. “such as”) provided herein, is intended merely to better illuminate embodiments of the disclosure and do not pose a limitation to the scope of the invention unless otherwise claimed. No language in the specification should be construed as indicating any non-claimed element as essential to each embodiment of the present invention.

The words “receiving,” “generating,” “extracting,” “determining,” “calculating,” and other forms thereof are intended to be open ended in that an item or items following any one of these words is not meant to be an exhaustive listing of such item or items or meant to be limited to only the listed item or items. The term “or” is used inclusively to refer to items in the alternative and in combination.

Different arrangements of the components depicted in the drawings or described above, as well as components and steps not shown or described are possible. Similarly, some features and sub-combinations are useful and can be employed without reference to other features and sub-combinations. Embodiments of the invention have been described for illustrative and not restrictive purposes, and alternative embodiments will become apparent to readers of this patent. Accordingly, the present invention is not limited to the embodiments described herein or depicted in the drawings, and various embodiments and modifications can be made without departing from the scope of the claims. The disclosed embodiments are merely exemplary of the disclosure, which can be embodied in various forms.

What is claimed is:

1. A computer-implemented method for automatically providing a stable Internet connection, the method being performed by User Equipment (UE) comprising at least one processor, the method comprising:
performing inter-frequency and inter-public land mobile network (PLMN) cell discovery to establish a current active connection between the UE and a PLMN;
generating information describing candidate alternative connections from cell frequency and quality metrics identified during the PLMN cell discovery, wherein:
current active connection metrics and past connection quality metrics are used to generate the information describing the candidate alternative connections; and
the information describing the candidate alternative connections comprises information describing a best available PLMN to which to connect;
transitioning the active connection of the UE from the current active connection to an alternative connection described in the information describing the candidate alternative connections; and
maintaining secondary connected device communications and upload processes uninterrupted between the UE and a secondary user device via local area network (LAN) during the transitioning of the active connection of the UE from the current active connection to the alternative connection.

2. The computer-implemented method of claim 1, wherein the performing the PLMN cell discovery further comprises:
receiving, from a serving cell, information comprising:
a list of frequencies,
a reference signal received quality (RSRQ), and
a PLMN identifier (ID);
storing the received information in a UE memory;
preparing information describing a summary of the received information; and
transmitting the summary of the received information to a remote server.

3. The computer-implemented method of claim 1, further comprising generating information describing the current active connection by combining PLMN cell discovery information describing characteristics of the current active connection with information describing:
quality information of the current active connection over time;
historical connection quality information of the discovered cells and geographically relevant cells, available to the UE via locally stored data and remotely archived data;
historic bandwidth and data transfer rates;
trending signal quality and strength;
speed of network transition;
number of active cells;
current quality information of discovered cells, made available via network discovery;
preferring high-bandwidth radio access technologies;
preferring low-traffic frequency bands; or
a combination thereof.

4. The computer-implemented method of claim 1, wherein the maintaining the secondary connected device communications and upload processes uninterrupted between the UE and the secondary user device further comprises preserving an active data connection of the secondary device by:
encapsulating data packets in the network traffic with additional data headers that direct network traffic to an intermediate server; and
removing, at the intermediate server, the additional data headers to enable:
additional routing of the data packets;
re-ordering of the data packets when the data packets are received out-of-order;
consolidating different network source Internet Protocol (IP) addresses into one single outbound IP address;
repeating data transmission of dropped packets; or
a combination thereof.

5. An apparatus configured to automatically provide a stable Internet connection, comprising:
an electronic processor configured to execute a set of computer-executable instructions;
a wireless cellular communications transceiver communicatively coupled to the electronic processor;
a local area network (LAN) transceiver communicatively coupled to the electronic processor; and
a memory communicatively coupled to the electronic processor and storing the set of computer-executable instructions, wherein the set of computer-executable instructions are configured to cause the electronic processor to:
perform inter-frequency and inter-public land mobile network (PLMN) cell discovery to establish a current active connection between User Equipment (UE) and a PLMN;
generate information describing candidate alternative connections from cell frequency and quality metrics identified during the PLMN cell discovery, wherein:
current active connection metrics and past connection quality metrics are used to generate the information describing the candidate alternative connections; and
the information describing the candidate alternative connections comprises information describing a best available PLMN to which to connect;
transition the active connection of the UE from the current active connection to an alternative connection described in the information describing the candidate alternative connections; and
maintain secondary connected device communications and upload processes uninterrupted between the UE and a secondary user device via local area network (LAN) during the transitioning of the active connection of the UE from the current active connection to the alternative connection.

6. The apparatus of claim 5, wherein the instructions configured to cause the electronic processor to perform the PLMN cell discovery further comprises instructions configured to cause the electronic processor to:
receive, from a serving cell, information comprising:
a list of frequencies,
a reference signal received quality (RSRQ), and
a PLMN identifier (ID);
store the received information in a UE memory;
prepare information describing a summary of the received information; and
transmit the summary of the received information to a remote server.

7. The apparatus of claim 5, wherein the memory further stores instructions configured to cause the electronic processor to generate information describing the current active connection by combining PLMN cell discovery information describing characteristics of the current active connection with information describing:
quality information of the current active connection over time;
historical connection quality information of the discovered cells and geographically relevant cells, available to the UE via locally stored data and remotely archived data;
historic bandwidth and data transfer rates;
trending signal quality and strength;
speed of network transition;
number of active cells;
current quality information of discovered cells, made available via network discovery;
preferring high-bandwidth radio access technologies;
preferring low-traffic frequency bands; or
a combination thereof.

8. The apparatus of claim 5, wherein the instructions configured to cause the electronic processor to maintain the secondary connected device communications and upload processes uninterrupted between the UE and the secondary user device further comprise instructions configured to cause the electronic processor to preserve an active data connection of the secondary device by:
encapsulating data packets in the network traffic with additional data headers that direct network traffic to an intermediate server; and
removing, at the intermediate server, the additional data headers to enable:
additional routing of the data packets;
re-ordering of the data packets when the data packets are received out-of-order;
consolidating different network source Internet Protocol (IP) addresses into one single outbound IP address;
repeating data transmission of dropped packets; or
a combination thereof.

9. A non-transitory computer-readable medium, comprising processor-executable instructions stored thereon configured to cause a processor to:
perform inter-frequency and inter-public land mobile network (PLMN) cell discovery to establish a current active connection between User Equipment (UE) and a PLMN;
generate information describing candidate alternative connections from cell frequency and quality metrics identified during the PLMN cell discovery, wherein:
current active connection metrics and past connection quality metrics are used to generate the information describing the candidate alternative connections; and
the information describing the candidate alternative connections comprises information describing a best available PLMN to which to connect;
transition the active connection of the UE from the current active connection to an alternative connection described in the information describing the candidate alternative connections; and
maintain secondary connected device communications and upload processes uninterrupted between the UE and a secondary user device via local area network (LAN) during the transitioning of the active connection of the UE from the current active connection to the alternative connection.

10. The non-transitory computer-readable medium of claim 9, wherein the processor-executable instructions stored thereon configured to cause the processor to perform the PLMN cell discovery further comprise processor-executable instructions configured to cause the processor to:
receive, from a serving cell, information comprising:
a list of frequencies,
a reference signal received quality (RSRQ), and
a PLMN identifier (ID);
store the received information in a UE memory;
prepare information describing a summary of the received information; and
transmit the summary of the received information to a remote server.

11. The non-transitory computer-readable medium of claim 9, further comprising processor-executable instructions stored thereon configured to cause the processor to generate information describing the current active connection by combining PLMN cell discovery information describing characteristics of the current active connection with information describing:
quality information of the current active connection over time;
historical connection quality information of the discovered cells and geographically relevant cells, available to the UE via locally stored data and remotely archived data;
historic bandwidth and data transfer rates;
trending signal quality and strength;
speed of network transition;
number of active cells;
current quality information of discovered cells, made available via network discovery;
preferring high-bandwidth radio access technologies;
preferring low-traffic frequency bands; or
a combination thereof.

12. The non-transitory computer-readable medium of claim 9, wherein the processor-executable instructions stored thereon configured to cause the processor to maintain the secondary connected device communications and upload processes uninterrupted between the UE and the secondary user device further comprise processor-executable instructions configured to cause the processor to preserve an active data connection of the secondary device by:
encapsulating data packets in the network traffic with additional data headers that direct network traffic to an intermediate server; and
removing, at the intermediate server, the additional data headers to enable:
additional routing of the data packets;
re-ordering of the data packets when the data packets are received out-of-order;
consolidating different network source Internet Protocol (IP) addresses into one single outbound IP address;
repeating data transmission of dropped packets; or
a combination thereof.

13. An apparatus configured to transmit continuous data to an endpoint computing device, the apparatus comprising:
an electronic processor configured to execute a set of computer-executable instructions;
a wireless cellular communications transceiver communicatively coupled to the electronic processor; and
a memory communicatively coupled to the electronic processor and storing the set of computer-executable instructions, wherein the set of computer-executable instructions are configured to cause the electronic processor to:
perform discovery to establish a current active connection between the electronic processor and the endpoint computing device via a first cellular communications network;
generate information describing candidate alternative cellular communications network connections, the information including a signal strength of an available, second alternative cellular communications network;
transition the current active connection from the first cellular communications network to the second alternative cellular communications network; and
maintain the transmission of continuous data to the endpoint computing device during the transitioning.

14. The apparatus of claim 13, wherein the set of computer-executable instructions are further configured to cause the electronic processor to:
encapsulate transmitted data in packets, wherein each of the packets includes respective header data.

15. The apparatus of claim 14, wherein the connection to the endpoint computing device includes a server configured to use the respective header data to organize the packets enabling the endpoint computing device to receive the continuous data during the transition.

16. The apparatus of claim 15, wherein the server is configured to use the respective header data to re-order one or more of the packets when at least one packet is received out of sequential order.

17. The apparatus of claim 15, wherein the performing the discovery further comprises:
receiving, from a serving cell, information comprising:
a list of frequencies, and
a cellular communications network identifier;
storing the received information in the memory;
preparing information describing a summary of the received information; and
transmitting the summary of the received information to the server.

18. The apparatus of claim 13, wherein the set of computer-executable instructions are further configured to cause the electronic processor to generate information describing the current active connection by combining discovery information describing characteristics of the current active connection with information describing:
quality information of the current active connection over time;
historical connection quality information of discovered cells and geographically relevant cells;
historic bandwidth and data transfer rates;
trending signal quality and strength;
speed of network transition;
number of active cells;
current quality information of discovered cells, made available via network discovery;
preferring high-bandwidth radio access technologies;
preferring low-traffic frequency bands; or
a combination thereof.

19. The apparatus of claim 13, wherein the maintaining the transmission of continuous data to the endpoint computing device during the transitioning further comprises preserving an active data connection of the endpoint computing device by:
encapsulating data packets in the network traffic with data headers that direct network traffic to an intermediate server; and
removing, at the intermediate server, the data headers to enable:
additional routing of the data packets;
re-ordering of the data packets when the data packets are received out-of-order;
consolidating different network source Internet Protocol (IP) addresses into one single outbound IP address;
repeating data transmission of dropped packets; or
a combination thereof.

20. The apparatus of claim 13, further comprising an interface device communicatively coupled to the electronic processor and configured to receive electronic information describing an image.
